(19) United States
(12) Patent Application Publication
(10) Pub. No.: US 2024/0410714 A1
(43) Pub. Date: Dec. 12, 2024

(54) GENERATING IMPROVED USER INTERFACES FOR PROVIDER COMPUTING DEVICES WITH COMPASS, DYNAMIC HALO, AND CONTEXTUAL INFORMATION SHAPES

(71) Applicant: Lyft, Inc., San Francisco, CA (US)

(72) Inventors: Aastha Bhargava, San Francisco, CA (US); Oleksii Huralnyk, Kiev (UA); Sangwoo Kim, Oakland, CA (US); Benjamin Kin Hoong Low, New York, NY (US); Robert William Sudekum, San Francisco, CA (US)

(21) Appl. No.: 18/333,340

(22) Filed: Jun. 12, 2023

(51) Int. Cl. G01C 21/36

(52) U.S. Cl. CPC G01C 21/3694; G01C 21/3635

(57) ABSTRACT

The present disclosure relates to systems, non-transitory computer-readable media, and methods for generating improved graphical user interfaces for provider computing devices by utilizing dynamic compass, halo, beacon, and contextual information shapes. To illustrate, the disclosed systems can utilize GPS data to determine the location of a provider computing device and generate a user interface that includes a digital map with a compass at the location of the provider computing device, a dynamic halo surrounding the compass, a contextual information shape adjacent to the halo, and a beacon adjacent to the dynamic halo indicating contextual directional information. In one or more embodiments, the disclosed system monitors various computing devices to determine status changes and modifies the dynamic halo, the contextual information shape, and/or the beacon to efficiently provide timely and efficient contextual information to the provider computing device.

### BACKGROUND

Recent years have seen significant developments in on-demand transportation systems that utilize mobile devices to coordinate across computer networks. Indeed, the proliferation of web and mobile applications has enabled requesting devices to utilize on-demand ride sharing systems to identify matches between provider devices and requester devices and coordinate across computer networks to initiate transportation from one geographic location to another. For instance, conventional transportation network systems can generate digital matches between provider devices and requester devices, and further track, analyze, and manage pick-up, transportation, and drop-off routines through digital transmissions across computer networks. Despite these recent advances, however, conventional transportation network systems continue to exhibit a number of drawbacks and deficiencies, particularly with regard to inefficiency of graphical user interfaces and operational inflexibility of implementing client devices.

For example, conventional systems often require significant time and user interactions to provide pertinent information to client devices. For example, to determine different information regarding transportation ride status, connectivity, ride matches, or navigational issues, conventional systems often require users to navigate through different user interfaces to identify pertinent information. As an initial matter, this wastes time and computer resources in generating and navigating through various user interfaces. In addition, in the context of on-demand transportation systems, these user interface inefficiencies also translate into significant occupational risks, inasmuch as significant user interface interactions with mobile devices can increase distraction and safety hazards.

Furthermore, conventional systems are also functionally rigid and inflexible. For example, conventional systems often provide information to provider computing devices in a static location within one or more user interfaces. This rigidity further exacerbates the inefficiencies discussed above, inasmuch as many provider computing devices lack sufficient screen real estate to provide all of the necessary information within a single user interface. Accordingly, the rigid, inflexible user interface approach leads to numerous user interfaces and/or interface elements that are time consuming and computationally expensive to navigate.

These, along with additional problems and issues, exist with conventional transportation network systems.

### SUMMARY

This disclosure describes one or more embodiments of methods, non-transitory computer-readable media, and systems that generate improved graphical user interfaces for provider computing devices by utilizing dynamic compass and contextual information shapes. For example, in one or more implementations, the disclosed systems monitor location information from provider computing devices, via one or more global positioning systems. The disclosed systems then generate a user interface that includes an interactive map displaying a compass at a determined location for a provider computing device. Furthermore, the disclosed systems generate a dynamic halo surrounding the compass as well as a contextual information shape adjacent to the compass and halo. The disclosed systems can detect changes in status over time, intelligently select contextual information items to surface, and modify the dynamic halo and contextual information shape to efficiently provide contextual information to the provider computing device. In addition, the disclosed systems can identify directional information corresponding to different states and generate a beacon that efficiently indicates this directional information within the user interface. The disclosed systems can intelligently select and change the pertinent contextual information displayed via the compass, halo, beacon, and/or contextual information shape. Moreover, in one or more embodiments, the disclosed systems modify the compass, for example to provide a changing compass representation that changes based on the pitch level of a camera view for displaying the digital map. In sum, the disclosed systems can utilize a variety of dynamic user interface elements to efficiently and flexibly convey dynamic contextual information to provider computing devices across computer networks.

### BRIEF DESCRIPTION OF THE DRAWINGS

The detailed description refers to the drawings briefly described below.

FIG. 1 illustrates providing a dynamic user interface with a compass, halo, contextual information shape, and/or beacon for display via a provider device in accordance with one or more embodiments in accordance with one or more embodiments.

FIG. 2 illustrates a compass, a disc, a halo, and a beacon in accordance with one or more embodiments.

FIG. 3 illustrates detecting statuses and modifying a dynamic halo based on the statuses in accordance with one or more embodiments.

FIG. 4 illustrates a plurality of different compasses, dynamic halos, and contextual information shapes corresponding to a plurality of different statuses in accordance with one or more embodiments.

FIG. 5 illustrates generating a plurality of beacons based on different directions corresponding to different statuses in accordance with one or more embodiments.

FIG. 6 illustrates generating and modifying a compass dynamic halo contextual information shape and or beacon in accordance with one or more embodiments.

FIG. 7 illustrates generating a plurality of compass representations based on a camera view in accordance with one or more embodiments.

FIG. 8 illustrates a block diagram of an environment for implementing a transportation matching system and a contextual user interface system in accordance with one or more embodiments.

FIG. 9 illustrates an example series of acts for matching provider devices to time priority airport transportation requests in accordance with one or more embodiments.

FIG. 10 illustrates a block diagram of a computing device for implementing one or more embodiments of the present disclosure.

FIG. 11 illustrates an example environment for a transportation matching system in accordance with one or more embodiments.

### DETAILED DESCRIPTION

This disclosure describes one or more embodiments of a contextual user interface system that generates improved graphical user interfaces for provider computing devices by utilizing a dynamic compass, halo, and contextual information shape. To illustrate, the contextual user interface system can utilize a global positioning system to determine the location of a provider computing device over time. In one or more embodiments, the contextual user interface system generates a user interface that includes a digital map with a compass element at the location of the provider computing device, a dynamic halo surrounding the compass, and a contextual information shape adjacent to (e.g., next to or nearby) the halo.

In one or more embodiments, the contextual user interface system monitors various computing devices (e.g., requestor computing devices, provider computing devices, and/or third-party servers) to determine status changes that impact the provider computing device. In response, the contextual user interface system can modify the dynamic halo and/or the contextual information shape to efficiently provide timely and efficient contextual information to the provider computing device. Specifically, the contextual user interface system can utilize a contextual information analysis model to select a contextual information item for a status (from a plurality of contextual information items) and modify the dynamic halo and/or contextual information shape to reflect the contextual information item. Moreover, in one or more implementations, the contextual user interface system determines a direction corresponding to different states that impact the provider computing device. The contextual user interface system can provide a beacon within the user interface adjacent to the halo that indicates a particular direction corresponding to contextual information displayed within the halo and/or contextual information shape. Moreover, as the contextual user interface system determines updating status changes, the contextual user interface system can intelligently select and change the pertinent contextual information displayed via the halo, beacon, and/or contextual information shape. Furthermore, in one or more embodiments, the contextual user interface system modifies the compass, for example to provide a changing compass representation (e.g., a two-dimensional or three-dimensional representation) that changes based on the pitch level of a camera view for displaying the digital map.

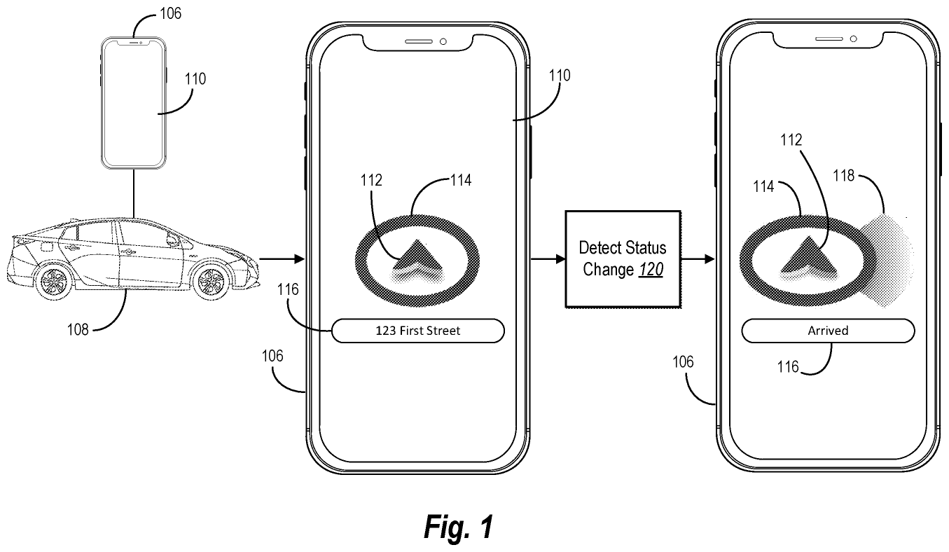

For example, FIG. 1 illustrates a contextual user interface system 104 providing a dynamic user interface with a compass, halo, contextual information shape, and/or beacon for display via a provider device in accordance with one or more embodiments. In particular, as shown in FIG. 1, the contextual user interface system 104 communicates with a provider computing device 106 corresponding to a provider vehicle 108. Specifically, the contextual user interface system 104 determines a location of the provider computing device 106 based on global positioning data. For example, the provider computing device 106 interacts with one or more satellites to generate global positioning data. The contextual user interface system 104 then receives the global positioning data via the provider computing device 106.

As shown in FIG. 1, upon determining the location of the provider computing device 106 (and/or the provider vehicle 108), the contextual user interface system 104 generates and provides a user interface 110 for display via the provider computing device 106. In particular, the user interface 110 includes a compass 112 surrounded by a dynamic halo 114. Moreover, the user interface 110 includes a contextual information shape 116 adjacent to the compass 112 and the dynamic halo 114. The contextual user interface system 104 places the compass 112, the dynamic halo 114, and the contextual information shape 116 within a digital map.

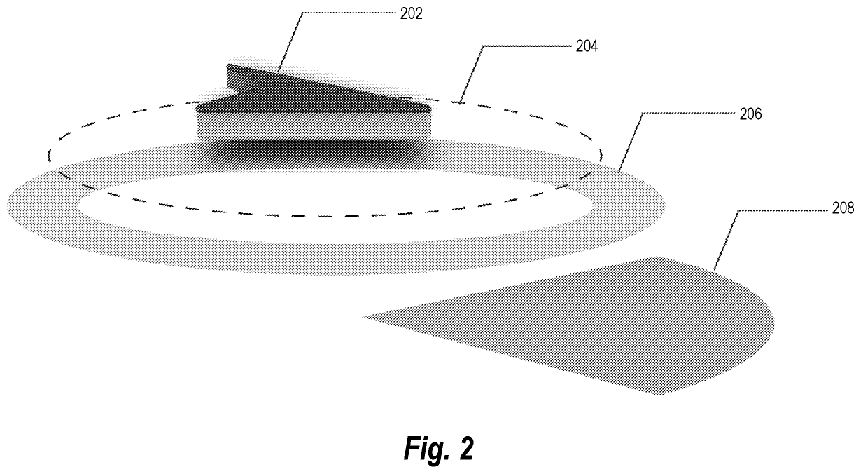

The compass 112, the dynamic halo 114, and the contextual information shape 116 each provide contextual information to the provider computing device 106. For example, the compass 112 indicates the location and direction of the provider computing device 106. The dynamic halo 114 includes coloring, shading, or animation to provide contextual information regarding the provider computing device 106. The contextual information shape 116 includes text and/or coloring to further provide additional contextual information to the provider computing device 106. Additional detail regarding the compass, halo, and contextual information shape is provided below (e.g., in relation to FIGS. 2-6).

The contextual user interface system 104 can intelligently determine what contextual information items to provide to the provider computing device 106 via the compass 112, the dynamic halo 114, and/or the contextual information shape 116. For example, the contextual user interface system 104 can identify a plurality of different states corresponding to a plurality of different contextual information items. The contextual user interface system 104 can apply a contextual information analysis model to select a contextual information item to surface. For example, the contextual user interface system 104 can utilize a machine learning model to analyze the various statuses (and corresponding contextual information items), generate a ranking order of the contextual information items, and surface the contextual information item (e.g., with the highest ranking). Thus, the contextual user interface system 104 can intelligently select a contextual information item corresponding to a particular status that is most pertinent or important and then generate the dynamic halo 114 and/or the contextual information shape 116 to reflect the selected contextual information item.

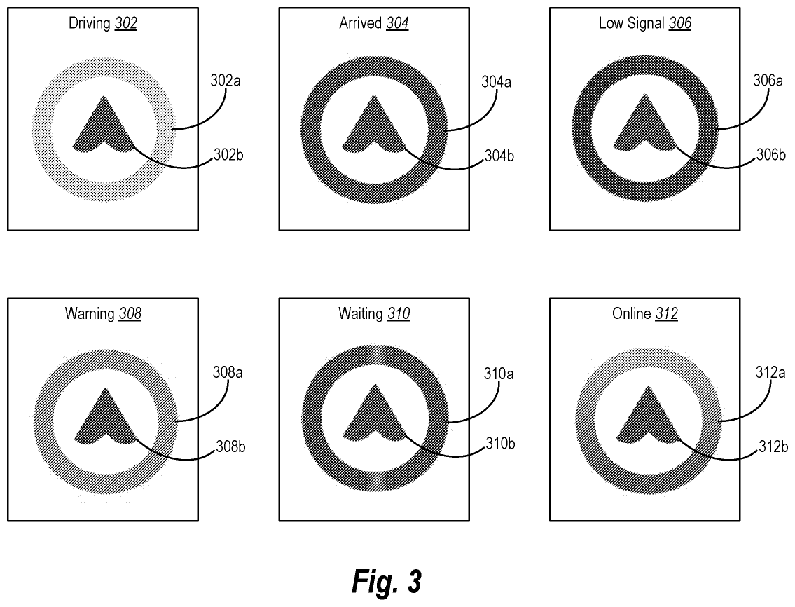

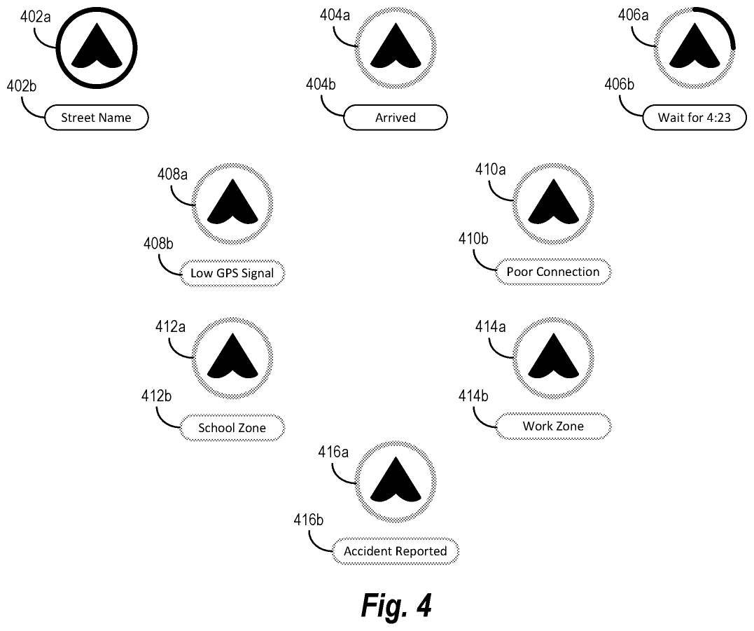

Moreover, the contextual user interface system 104 can select and modify the compass 112, the dynamic halo 114, and/or the contextual information shape 116 based on changing conditions. For example, FIG. 1 illustrates the contextual user interface system 104 performing an act 120 of detecting a status change. For example, the contextual user interface system 104 can determine a change in external signals available to the provider computing device 106 (e.g., a loss of GPS signals or a loss of connectivity); a change in transportation ride state corresponding to a transportation matching system (e.g., assigned a transportation request, arrived at a pickup or dropoff location, coming into an online state); or a change in transportation features corresponding to the location of the provider computing device (e.g., a lane closure, a change in traffic, or a need for a traffic maneuver). Additional detail regarding monitoring and determining different statuses is provided below (e.g., in relation to FIGS. 3-4).

As shown, in response to detecting the status change, the contextual user interface system 104 modifies the user interface 110 to reflect information regarding the status change. For example, the contextual user interface system 104 modifies the halo 114 to include a different color, shading, and/or animation. Similarly, the contextual user interface system 104 modifies the contextual information shape 116 to include a different set of contextual information text based on the status change.

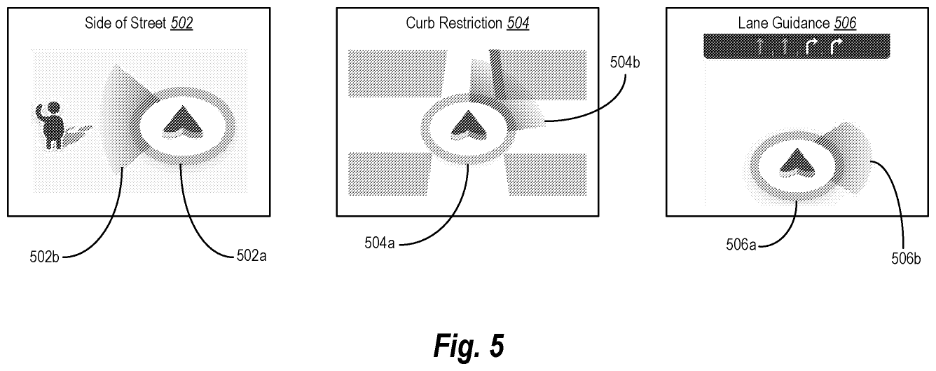

In addition, the contextual user interface system 104 also adds a beacon 118 to the user interface 110. In particular, in performing the act 120 of determining the status change, the contextual user interface system 104 also determines directional information (e.g., directional information corresponding to a particular status or state). In response, the contextual user interface system 104 provides the beacon 118 on a side of the halo 114 corresponding to the directional information. Thus, for example, the contextual user interface system 104 determines a side of the street for a drop off location, and, in response, provides the beacon 118 on the side of the halo 114 corresponding to the determined side of the street. Additional detail regarding the halo and directional indicators is provided below (e.g., in relation to FIG. 5).

As mentioned, in response to detecting a status change, the contextual user interface system 104 can again intelligently determine what contextual information items to provide to the provider computing device 106. Indeed, the contextual user interface system 104 can again utilize a contextual information analysis model to identify a plurality of different states (after the status change) corresponding to a plurality of different contextual information items. The contextual user interface system 104 can apply a contextual information analysis model to select contextual information item from the plurality of contextual information items. Thus, the contextual user interface system 104 can iteratively analyze statuses and corresponding contextual information items as they change over time, select the pertinent contextual information item, and modify the halo 114, the contextual information shape 116, and/or the beacon 118 to reflect the selected contextual information item.

As illustrated in FIG. 1, the contextual user interface system 104 can provide a variety of technical advantages or improvements relative to conventional systems. For example, the contextual user interface system 104 can provide significant efficiency improvements in comparison to conventional systems. To illustrate, by providing and updating the compass 112, the halo 114, the contextual information shape 116, and/or the beacon 118, the contextual user interface system 104 can provide accurate contextual information to provider computing devices, in real-time, via a single user interface. Indeed, the contextual user interface system 104 can avoid user interactions and computer resources utilized by conventional systems to generate and navigate between user interfaces to identify pertinent information (e.g., upcoming traffic changes or side of the street information). Indeed, via the compass 112, the halo 114, the contextual information shape 116, and/or the beacon 118, the contextual user interface system 104 can provide information regarding transportation ride status, navigational features, directional indicators, and/or computing device connectivity via a single, updating user interface.

Furthermore, the contextual user interface system 104 can improve operational flexibility relative to conventional systems. Indeed, the contextual user interface system 104 can dynamically update the compass 112, the halo 114, the contextual information shape 116, and/or the beacon 118 (e.g., utilize a contextual information analysis model) to include varied, pertinent contextual information over time. Thus, rather than providing static interface elements that indicate particular information across different user interfaces, the contextual user interface system 104 can dynamically change the contextual information conveyed via the halo 114, the contextual information shape 116, and/or the beacon 118 in response to changing status over time. Indeed, in some implementations, the contextual user interface system 104 utilizes the utilize a contextual information analysis model to intelligently determine a rank ordering of contextual information items and modifies the type of textual information displayed via the halo 114, the contextual information shape 116, and/or the beacon 118 based on this intelligent rank ordering. The contextual user interface system 104 also dynamically modifies this rank ordering based on changed conditions to dynamically provide pertinent information for display to the provider computing device 106.

In addition to improved efficiency and flexibility, the contextual user interface system 104 also provides accurate information to provider computing devices via a user interface that improves safety of on-demand transportation systems. Indeed, by reducing time and interactions and dynamically providing pertinent contextual information in clear user-interface elements, the contextual user interface system 104 can provide accurate information that reduces distractions and improves safety in utilizing provider computing devices.

As illustrated by the foregoing discussion, the present description utilizes a variety of terms to describe features and advantages of the contextual user interface system 104. For example, as used herein, the term “provider device” (or provider computing device) refers to a computing device associated with a transportation provider or driver (e.g., a human driver or an autonomous computer system driver) that operates a transportation vehicle. For instance, a provider device refers to a mobile device such as a smartphone or tablet operated by a provider—or a device associated with an autonomous vehicle that drives along transportation routes.

In one or more implementations, the contextual user interface system 104 generates a transportation match between the provider computing device 106 and a requestor device. In particular, a requestor device can submit a transportation request and the contextual user interface system 104 can utilize a transportation matching algorithm to generate a transportation match between the requestor device and the provider computing device 106.

As used herein, the term “requester device” (or requestor computing device) refers to a computing device associated with a requester that submits a transportation request to a transportation matching system. For instance, a requester device receives interaction from a requester in the form of user interaction to submit a transportation request. After the transportation matching system matches a requester (or a requester device) with a provider (or a provider device), the requester can await pickup by the provider at a predetermined pick-up location. Upon pick-up, the provider transports the requester to a drop-off location specified in the requester's transportation request. Accordingly, a requester may refer to (i) a person who requests a request or other form of transportation but who is still waiting for pickup or (ii) a person whom a transportation vehicle has picked up and who is currently riding within the transportation vehicle to a drop-off location.

Similarly, as used herein, the term “transportation request” refers to a request from a requesting device (i.e., a requester device) for transport by a transportation vehicle. In particular, a transportation request includes a request for a transportation vehicle to transport a requester or a group of individuals from one geographic area to another geographic area. A transportation request can include information such as a pick-up location, a destination location (e.g., a location to which the requester wishes to travel), a request location (e.g., a location from which the transportation request is initiated), location profile information, a requester rating, or a travel history. As an example of such information, a transportation request may include an address as a destination location and the requester's current location as the pick-up location. A transportation request can also include a requester device initiating a session via a transportation matching application and transmitting a current location (thus, indicating a desire to receive transportation services from the current location).

As used herein, the term “compass” refers to a user interface element indicating location and/or direction. For instance, the compass 112 indicates the location of the provider computing device 106. In addition, the compass 112 is oriented to indicate a direction of travel corresponding to the provider computing device 106 along a route (e.g., a route from a current location to a destination, such as a pickup or dropoff location).

In addition, as used herein the term “halo” (or dynamic halo) refers to a shape surrounding or encompassing another user interface element. Thus, for example, the dynamic halo 114 includes a shape (e.g., circle, square, oval, etc.) that surrounds the compass 112. The dynamic halo 114 can include one or more properties that can change over time to convey contextual information corresponding to the provider computing device (e.g., contextual information regarding a ride/transportation request). Thus, for example, the contextual user interface system 104 can change a color, shape, animation, or shading of the dynamic halo 114.

Moreover, as used herein the term “contextual information shape” refers to a user interface element that includes a shape surrounding textual information. For example, a contextual information shape includes a user interface element adjacent to (e.g., a fixed distance below) a compass and/or halo that includes textual information indicating current context corresponding to a provider computing device within a transportation matching system. A contextual information shape can include a variety of shapes. For instance, in relation to FIG. 1, the contextual information shape 116 includes a pill shape that surrounds textual information. In some implementations, the contextual user interface system 104 utilizes a different shape, such as an oval, rectangle, or other polygon.

As used herein, the term “status change” refers to a change in status (e.g., characteristics or condition) of a provider computing device. For instance, the term status change can include a change in external signals (e.g., cellular signals, GPS signals, wi-fi signals, or Bluetooth signals) available to the provider computing device; a change in transportation ride state (e.g., online, offline, driving, waiting, or transporting) corresponding to a transportation matching system; or a change in transportation features (e.g., accident, lane change, curb restriction) corresponding to the location of the provider computing device. Additional examples of different statuses and status changes are provided below. Similarly, the term “contextual information” includes a feature, characteristic, or condition corresponding to a provider computing device and/or transportation request.

As used herein, the term “contextual information” (or “contextual information item”) refers to a description, feature, or characteristic corresponding to a provider device and/or a transportation request. Thus, for example, different statuses can correspond to different contextual information items. To illustrate, a waiting status can correspond to a waiting time contextual information item. Similarly, a driving status can correspond to a street contextual information item. The contextual user interface system 104 can maintain an updating repository of contextual information items corresponding to different statuses. Moreover, the contextual user interface system 104 can intelligently select a particular contextual information item to surface to a provider computing device via a dynamic halo, contextual information shape, and/or beacon.

As used herein, the term “beacon” refers to a user interface element proximate to a side of a dynamic halo. In particular, a beacon includes a colored user interface shape attached to a side of the dynamic halo that corresponds to a direction of a status or status change. A beacon can include a variety of shapes (e.g., a cone shape or an arrow shape). The contextual user interface system 104 can modify the shape, color, or animation of the beacon based on detecting different statuses (or status changes).

As just mentioned, the contextual user interface system 104 can provide a coordinated compass, halo, contextual information shape, and/or beacon for display via a provider computing device. For example, FIG. 2 illustrates a compass 202, a disc 204, a halo 206, and a beacon 208 in accordance with one or more embodiments.

As shown in FIG. 2, the compass 202 can include a two-dimensional or three-dimensional representation indicating a direction corresponding to a provider computing device. For example, the compass 202 can include a directional indicator aligned to a direction of travel or orientation of the provider computing device. The contextual user interface system 104 analyzes GPS data and/or other signals (e.g., inertial measurement unit data or “IMU” data) to determine the location and/or direction of the provider computing device. The contextual user interface system 104 can change orientations or directions of the compass 202 to align to the orientation or direction of a provider computing device. Thus, the contextual user interface system 104 can detect the orientation or direction of a provider computing device and modify the alignment of the compass 202 based on the provider computing device. Although illustrated as a particular polygonal shape the compass 202 can include a variety of different shapes.

As shown in FIG. 2, the contextual user interface system 104 can also utilize a disc 204. In particular the disc 204 can set apart the compass 202 from the dynamic halo 206. In some implementations the disc 204 sets the compass 202 afloat relative to the dynamic halo 206. In some embodiments where the compass 202 comprises a three-dimensional shape, the disc 204 indicates an elevation of the compass 202.

As further illustrated in FIG. 2, the contextual user interface system 104 can also generate the dynamic halo 206. In relation to FIG. 2, the dynamic halo 206 includes a ring that encompasses the compass 202. The dynamic halo 206 can provide an indication of contextual information corresponding to a transportation request. For example, the dynamic halo 206 can change colors in response to the contextual user interface system 104 detecting a status change. Although illustrated as a ring, the contextual user interface system 104 can utilize a variety of different shapes to generate the dynamic halo 206. For example, the contextual user interface system 104 can generate the dynamic halo 206 as an oval a polygon or some other shape. In some implementations the contextual user interface system 104 modifies the shape of the dynamic halo 206 based on detecting a status change.

As shown in FIG. 2, the contextual user interface system 104 can also generate a beacon 208. The beacon 208 indicates a direction corresponding to contextual information related to a transportation request or service. For example, the contextual user interface system 104 can detect a direction corresponding to a pickup location, navigation features, or other contextual information/status and generate the beacon 208 to align to the detected direction. In particular, the compass 202 determines a side of the dynamic halo 206 corresponding to a direction of the contextual information and places the beacon 208 on the determined side. Thus, the beacon 208 can draw attention to an external event that is happening around the provider vehicle, while being pointed in the direction of that event.

Although FIG. 2 illustrates the beacon 208 having a particular shape and size, the contextual user interface system 104 can generate the beacon 208 utilizing a variety of different shapes and sizes. For example, the contextual user interface system 104 can generate the beacon 208 to include a partial ring shape an arrow shape or a polygonal shape. Moreover, the contextual user interface system 104 can position the beacon 208 inside of (e.g., encompassed by) the halo 206, outside of the halo 206, or within the dynamic halo 206. Similar to the dynamic halo 206, the contextual user interface system 104 can also modify the color size location or shape of the beacon 208 based on detecting different statuses corresponding to a transportation request or service. For example, in response to detecting a status change, the contextual user interface system 104 can modify the color of the beacon 208 from blue to red. Similarly, the contextual user interface system 104 can expand the size of the beacon 208 or modify the shape of the beacon 208 (e.g., to emphasize or deemphasize a particular direction).

Moreover, the contextual user interface system 104 can also modify the direction of the beacon 208. For example, as a provider computing device approaches a pickup location, the direction of the pickup location relative to the provider device changes. Accordingly, the contextual user interface system 104 can detect a change in direction resulting from a change in location of the provider computing device and/or the requester computing device and modify the direction of the beacon 208 in response.

As just mentioned, the contextual user interface system 104 can detect a variety of different statuses and status changes to modify one or more features of a dynamic halo, beacon, or contextual information shape. FIG. 3 illustrates the contextual user interface system 104 detecting a variety of different statuses and modifying a dynamic halo based on the detected statuses in accordance with one or more embodiments. For example, FIG. 3 illustrates the contextual user interface system 104 detecting a plurality of statuses 302-312. In addition, FIG. 3 shows the contextual user interface system 104 generating a plurality of dynamic halos 302a-312a and compasses 302b-312b corresponding to the plurality of statuses 302-312.

For example, FIG. 3 illustrates the contextual user interface system 104 detecting a driving status 302 (e.g., an example of a ride status or change in transportation ride status). In particular, the driving status 302 indicates that a provider computing device is driving to a new location (e.g., a pickup location, a dropoff location, or another location such as a waiting location). Moreover, in response to the contextual user interface system 104 detecting the driving status 302, the contextual user interface system 104 generates a first dynamic halo 302a and a first compass 302b. As shown, the first dynamic halo 302a includes a first color. In one or more embodiments, the contextual user interface system 104 maps different driving statuses to predetermined colors corresponding to the driving statuses. Thus, upon detecting a particular status or status change, the contextual user interface system 104 maps the status to the predetermined color and provides the predetermined color for display as part of the first dynamic halo 302a. In some implementations, the contextual user interface system 104 dynamically determines a color corresponding to a particular status. For example, the driving status 302 can have different colors depending on the speed, location, orientation, or surrounding traffic corresponding to a provider computing device.

FIG. 3 illustrates a variety of additional statuses including an arrived status 304 (e.g., an example of a ride status or change in transportation ride status). In particular the contextual user interface system 104 detects the arrived status based on GPS data indicating that the provider computing device has arrived at a particular location (e.g., a pickup location, a dropoff location, or a waiting location). As illustrated, in response to detecting the arrived status 304, the contextual user interface system 104 generates a second dynamic halo 304a having a second color. In addition, the contextual user interface system 104 generates a second compass 304b. Although the second compass 304b is illustrated as having the same color as the first compass 302b the contextual user interface system 104 can generate different compasses having different colors based on different contextual information.

In addition, FIG. 3 also illustrates the contextual user interface system 104 detecting a low signal status 306 (e.g., an example of an external signal status or external signal status change). In particular, the contextual user interface system 104 determines that a signal corresponding to the provider computing device is below a particular threshold. For example, the contextual user interface system 104 determines the low signal status 306 based on determining that a cellular signal corresponding to the provider computing device has dropped below a threshold signal level. The contextual user interface system 104 can also determine a low signal status based on detecting that a Wi-Fi signal, GPS signal, or local connection signal (e.g., Bluetooth), has failed or dropped below a threshold strength. Thus, for example, the contextual user interface system 104 can detect the low signal status 306 when a provider computing device enters a tunnel or enters a region without cellular service coverage. In response, the contextual user interface system 104 can generate a third dynamic halo 306a having a third color and a third compass 306b.

As shown in FIG. 3, the contextual user interface system 104 also detects a warning status 308 (e.g., an example of a transportation feature corresponding to a location of a provider device or a change in transportation features corresponding to a location of a provider device). In particular, the contextual user interface system 104 can detect the warning status 308 based on an elevated transportation risk corresponding to a provider computing device. To illustrate, the contextual user interface system 104 can detect the warning status 308 based on identifying a traffic accident, traffic construction, road closure, lane closure, or other transportation feature that could increase transportation risk for the provider computing device. As shown in FIG. 3, in response to detecting the warning status 308 the contextual user interface system 104 can generate a fourth dynamic halo 308a having a fourth color and a fourth compass 308b.

In addition, FIG. 3 illustrates the contextual user interface system 104 detecting a waiting status 310 (e.g., an example of a transportation ride status or change in transportation ride status). In particular, the contextual user interface system 104 determines the waiting status 310 based on detecting that a provider computing device is waiting for a transportation event to occur. For example, the contextual user interface system 104 can determine the waiting status 310 based on detecting that a provider computing device has arrived at a pickup location and a requester computing device has not yet arrived at the pickup location. Similarly, the contextual user interface system 104 can determine that a provider computing device has arrived at a waiting location and has not yet received a transportation match for a transportation request.

As shown in FIG. 3, in response to detecting the waiting status 310 the contextual user interface system 104 generates a fifth dynamic halo 310a and a fifth compass 310b. As shown, the fifth dynamic halo 310a includes multiple colors and an animation. In particular, the dynamic halo 310a illustrates a color gradient (e.g., between blue and red) within the halo that is animated according to a particular pattern (e.g., rotating/spinning around the halo or expanding/contracting within the halo). The contextual user interface system 104 can generate different colors and different animations for a variety of different statuses including the different statuses illustrated in FIG. 3.

Moreover, as shown in FIG. 3 the contextual user interface system 104 also detects an online status 312 (e.g., an example of a change in transportation ride status). In particular, the contextual user interface system 104 detects the online status 312 upon determining that a provider computing device has changed to an online status indicating that the provider computing device is available to provide transportation services (e.g., available to receive a transportation match corresponding to a transportation request). As shown, in response to detecting the online status 312, the contextual user interface system 104 generates a sixth dynamic halo 312a and a sixth compass 312b. In relation to FIG. 3, the sixth dynamic halo 312a includes a color gradient (e.g., between blue and green). As mentioned previously, the contextual user interface system 104 can select a variety of color combinations gradients or animations for different statuses or status changes.

To provide an example, if a provider computing device is in an active ride (on the way to pick up a passenger or on the way to the destination), the contextual user interface system 104 can generate a dynamic halo colored dark indigo. If the passenger computing device is not in an active ride, the dynamic halo will be colored light indigo. Moreover, while the passenger computing device is waiting for the requestor computing device, the dynamic halo will be used as a circular timer (light indigo to dark indigo).

Although FIG. 3 illustrates a variety of detected statuses and corresponding dynamic halos and compasses the contextual user interface system 104 can detect a variety of additional statuses and generate a variety of different dynamic halos and compasses. Thus, for example, although not illustrated, the contextual user interface system 104 can also detect an offline status indicating that a provider computing device is not available to provide transportation services (and generate a corresponding dynamic halo corresponding to the offline status).

As mentioned above, the contextual user interface system 104 can also generate a contextual information shape that includes textual information corresponding to a particular status or status change. For example, FIG. 4 illustrates a plurality of different compasses, dynamic halos, and contextual information shapes corresponding to a plurality of different statuses in accordance with one or more embodiments. As shown, each status or status change can have a different dynamic halo color, animation, or gradient. Moreover, as illustrated the contextual information shape can also include different textual information, different colors, different animations, or different gradients.

For example, in response to detecting a first status (e.g., a driving status), the contextual user interface system 104 generates a first dynamic halo 402a and a first contextual information shape 402b. In particular, the first contextual information shape 402b includes textual information indicating a street name or other location information (e.g., city, region) corresponding to the provider computing device. The contextual user interface system 104 can update the textual information as the location of the provider computing device changes. Thus, for example, upon detecting that the provider computing device has turned from a first street to a second street the contextual user interface system 104 can update the textual information in the contextual information shape while maintaining the same color and other features of the dynamic halo 402a and the first contextual information shape 402b.

As shown in FIG. 4, in response to detecting a second status (e.g., an arrived status), the contextual user interface system 104 generates a second dynamic halo 404a and a second contextual information shape 404b having different textual information. Specifically, the second dynamic halo 404a has a second color and the second contextual information shape 404b includes textual information indicating that the provider computing device has arrived. Notably, the colors of the second dynamic halo 404a and the second contextual information shape 404b can be different. The contextual user interface system 104 can coordinate colors between the dynamic halo and the contextual information shape or utilize different colors between the dynamic halo and the contextual information shape depending on the particular status or status change at issue.

As shown in FIG. 4, in response to detecting a third status (e.g., a waiting status), the contextual user interface system 104 generates a third dynamic halo 406a and a third contextual information shape 406b with different textual information. In particular, the contextual user interface system 104 identifies a waiting time corresponding to the waiting status and displays the waiting time as part of the textual information of the third contextual information shape 406b. Specifically, the contextual user interface system 104 displays a countdown timer within the third contextual information shape 406b. In addition, the contextual user interface system 104 generates the third dynamic halo 406a such that it also displays an indicator of the waiting time. In particular, the color of the third dynamic halo 406a changes (e.g., one color shrinks and another color expands) to indicate remaining waiting time. Thus, the contextual user interface system 104 can generate dynamic halos and contextual information shapes that include dynamic information such as a countdown timer.

As shown in FIG. 4, in response to detecting a fourth status (e.g., a low signal status such as a low GPS signal), the contextual user interface system 104 generates a fourth dynamic halo 408a and a fourth contextual information shape 408b with different textual information (e.g., “Low GPS Signal”). In particular, the contextual user interface system 104 generates the fourth dynamic halo 408a and the fourth contextual information shape 408b to have the same color. As mentioned above, in some implementations the contextual user interface system 104 coordinates color between dynamic halos and contextual information shapes and in some embodiments the contextual user interface system 104 utilizes different colors between dynamic halos and contextual information shapes.

Thus, to provide a specific example, in some implementations the contextual user interface system 104 detects that the provider computing device is experiencing low GPS connectivity. In response, the contextual user interface system 104 will grey out the dynamic halo and the contextual information shape will show “Low GPS Signal.”

As shown in FIG. 4, the contextual user interface system 104 can detect a variety of different statuses and generate different dynamic halos with different contextual information shapes having different textual information. For instance, in response to detecting a poor connection (e.g., poor connection with a transportation matching system or cellular service system), the contextual user interface system 104 generates a fifth dynamic halo 410a and a fifth contextual information shape 410b with textual information indicating the poor connection. Similarly, in response to detecting that a provider computing device is in a school zone or a work zone, the contextual user interface system 104 generates the sixth dynamic halo 412a and the sixth contextual information shape 412b or the seventh dynamic halo 414a and the seventh contextual information shape 414b. Moreover, in response to detecting an accident corresponding to a route of a provider computing device, the contextual user interface system 104 generates the eighth dynamic halo 416a in the eight contextual information shape 416b.

In some implementations, the contextual user interface system 104 selects different colors corresponding to different types of contextual information. For example, the contextual user interface system 104 can utilize a first color for the dynamic halos 402a-406a and the contextual information shapes 402b-406b. The contextual user interface system 104 can utilize a second color for the dynamic halos 408a-410a and the contextual information shapes 408b-410b. The contextual user interface system 104 can utilize a third color for the dynamic halos 412a-416a and the contextual information shapes 412b-416b.

As mentioned above, the contextual user interface system 104 can also generate a beacon indicating a direction corresponding to a particular status or status change. For example, FIG. 5 illustrates generating a plurality of beacons based on different directions corresponding to different statuses in accordance with one or more embodiments. Specifically, FIG. 5 illustrates a plurality of directions 502-506 corresponding to different statuses with a corresponding plurality of halos 502a-506a and beacons 502b-506b.

For example, the contextual user interface system 104 detects a side of street direction 502 corresponding to a pickup or drop off location. Specifically, the contextual user interface system 104 determines a particular status (e.g., driving, arriving, or departing) and determines the side of street direction 502 corresponding to the particular status. In response, the contextual user interface system 104 generates the beacon 502b on a side of the dynamic halo 502a such that the beacon 502b aligns to the side of street direction 502. For example, the contextual user interface system 104 determines a current location of a provider computing device and determines a location of the pickup or dropoff location. The contextual user interface system 104 determines a vector or direction between the current location and the location of the pickup or dropoff location. The contextual user interface system 104 then places the beacon 502b on the dynamic halo 502a at a position corresponding to the vector/direction. Thus, upon detecting that a pickup location is on the left side of a provider computing device the contextual user interface system 104 generates the beacon 502b on the left side of the dynamic halo 502a.

Similarly, as shown in FIG. 5, the contextual user interface system 104 detects a curb restriction direction 504 corresponding to a particular status (e.g., a driving status or arriving status). In response, the contextual user interface system 104 generates the beacon 504b adjacent to the halo 504a to point to the curb restriction. The contextual user interface system 104 also selects a color corresponding to the beacon 504b. For example, the contextual user interface system 104 can color the beacon 504b in a red color to indicate a prohibited or restricted driving or parking location. As shown, the contextual user interface system 104 can also provide an indicator of the restricted curb within a digital map (e.g., by coloring the curb itself red within the digital map).

Moreover, as shown in FIG. 5, the contextual user interface system 104 detects a lane guidance direction 506 (or other navigation direction) corresponding to a particular status (e.g., a driving status). In particular, the contextual user interface system 104 detects that a provider computing device needs to change lanes to remain on a particular route. The contextual user interface system 104 determines a particular direction corresponding to navigating the provider computing device in the proper direction and generates the beacon 506b to align with the particular direction. Thus, as shown, upon detecting that a provider computing device needs to change lanes toward the right, the contextual user interface system 104 generates the beacon 506b on the right side of the dynamic halo 506a.

To provide a specific example, if the contextual user interface system 104 detects a safety-related road event (e.g., road hazard, curb restriction, speed trap), the contextual user interface system 104 will utilize the dynamic halo, contextual information shape, and beacon to provide coordinated, contextual information. For example, the dynamic halo will likely change colors, contextual information shape will contain a message regarding the safety alert, and the beacon will indicate a direction of the road event (e.g., side of the road or direction on the road). Similarly, for critical maneuvers/complex intersections, the contextual user interface system 104 can use the beacon to direct provider computing devices (e.g., towards a road for turning onto). For example, at a highway fork, the beacon can highlight the fork branch to take. Moreover, the contextual user interface system 104 can make use of the beacon and dynamic halo to signal filter lanes in order to make an exit or to stay on the current road. For example, if a provider computing device is on the left-most lane on a highway and has an exit coming up in a short distance, the beacon and dynamic halo will signal to filter 4 lanes to the right now in order to make it in time.

Although FIG. 5 illustrates specific examples of directions corresponding to particular contextual features and statuses the contextual user interface system 104 can generate a beacon corresponding to a variety of different directions statuses architectural information. Thus, for example, upon detecting a traffic accident the contextual user interface system 104 can determine a direction from that provider computing device to the traffic accident and provide a beacon that aligns with the direction. In addition, the contextual user interface system 104 can generate a beacon indicating a direction of a closed lane, a pothole, a direction of needed navigation, a direction of a requestor computing device, a direction of an upcoming freeway exit, a direction of an available parking location, or a direction of another feature or item.

In some implementations, the contextual user interface system 104 generates a color of the beacon that is the same as a halo or contextual information shape. In some implementation, the contextual user interface system 104 generates a beacon that is a different color than the halo and/or contextual information shape. The contextual user interface system 104 can also modify a shape, animation, or size of the beacon.

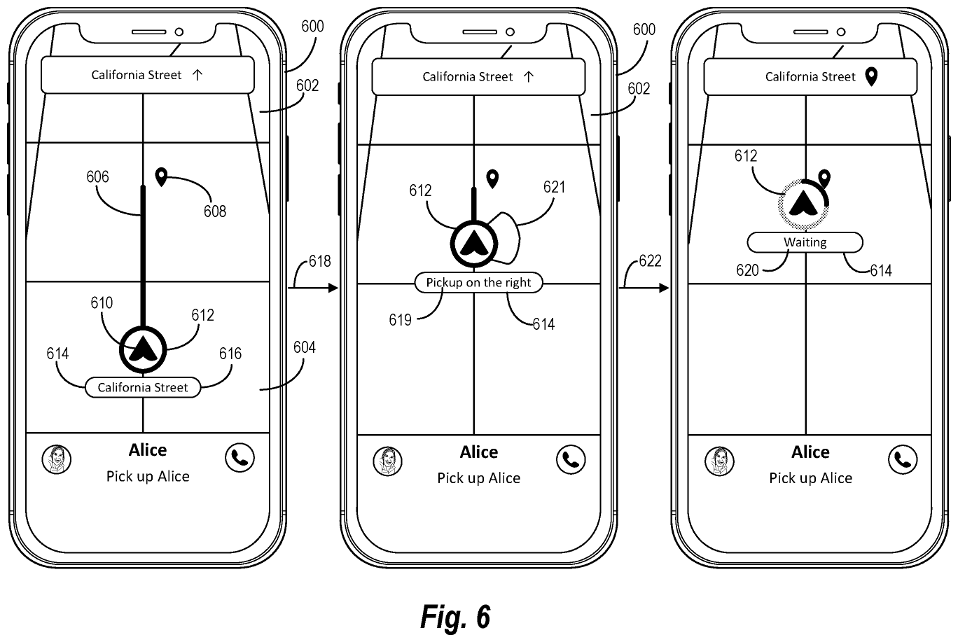

As mentioned above, the contextual user interface system 104 can provide a compass, halo, contextual information shape, and/or beacon for display with a digital map as part of a user interface on a client device. FIG. 6 illustrates the contextual user interface system 104 generating and modifying a compass dynamic halo contextual information shape and/or beacon in accordance with one or more embodiments.

Specifically, FIG. 6 illustrates a client device 600 displaying a user interface 602. As shown, the user interface 602 includes a digital map 604. The digital map 604 includes streets or roads and a route 606 along the streets or roads to a destination location 608 (e.g., a pickup location for a requester computing device). As illustrated, the user interface includes a compass 610 surrounded by a dynamic halo 612 with a contextual information shape 614 that includes textual information 616. In particular, the contextual user interface system 104 orients the compass 610 in the direction of travel along the route 606 (e.g., based on GPS data and/or IMU data). Moreover, the contextual user interface system 104 detects a current status of the provider computing device (i.e., a driving status). In response, the contextual user interface system 104 selects a particular color and generates the halo 612 based on that color. In addition, based on the current status the contextual user interface system 104 generates the contextual information shape 614 having the same color as the halo 612. Further, based on the current status the contextual user interface system 104 selects the textual information 616 indicating the current street/location of the provider computing device.

As shown in FIG. 6, the contextual user interface system 104 can monitor the provider computing device and detect a status change 618. Specifically, the contextual user interface system 104 monitors GPS data corresponding to the provider computing device and detects the status change 618 that includes changing from a driving status to an arriving status. For instance, based on determining that the provider computing device is within a threshold distance or time of a destination based on GPS data, the contextual user interface system 104 can detect the status change 618.

In response to detecting the status change 618, the contextual user interface system 104 modifies the dynamic halo 612 and/or the contextual information shape 614. For example, the contextual user interface system 104 can modify the color of the dynamic halo 612 and the color of the contextual information shape 614. Moreover, as shown in FIG. 6 the contextual user interface system 104 can modify the contextual information shape to include modified textual information 619. Specifically, the modified textual information 619 indicates a direction for a pickup location corresponding to the arriving status.

In addition, based on the status change 618 the contextual user interface system 104 also generates a beacon 621. In particular, the contextual user interface system 104 detects a direction corresponding to the new status (e.g., that the destination location 608 for the arrival status is to the right of the passenger computing device). In response, the contextual user interface system 104 generates the beacon 621 to align with the direction corresponding to the new status.

The contextual user interface system 104 can further modify the halo contextual information shape and/or beacon based on detecting an additional status change. For example, as illustrated the contextual user interface system 104 detects an additional status change 622 (i.e., a change from an arriving state to a waiting state). For example, the contextual user interface system 104 analyzes GPS data indicating that the provider computing device has arrived and stopped for a threshold period of time. In response, the contextual user interface system 104 removes the beacon 621 and modifies the halo 612 and the contextual information shape 614. Specifically, the contextual user interface system 104 modifies the color of the dynamic halo 612 and the color of the contextual information shape 614. In addition, the contextual user interface system 104 generates further modified textual information 620 corresponding to the waiting status. Moreover, the contextual user interface system 104 modifies the dynamic halo 612 to indicate a time remaining corresponding to the waiting status. As mentioned above, in some implementations the contextual user interface system 104 provides the remaining time as part of the further modified textual information 620 of the contextual information shape 614.

As illustrated in FIG. 6, the contextual user interface system 104 intelligently monitors the provider computing device and provides dynamic contextual information for different statuses and status changes through a single user interface. In particular, the contextual user interface system 104 intelligently modifies the dynamic halo 612, the contextual information shape 614, and the beacon 621 in relation to a compass indicating a direction of the provider computing device to efficiently provide a variety of accurate, up-to-date pertinent information that changes overtime as a provider computing device operates.

As mentioned above, in some implementations, the contextual user interface system 104 utilizes a contextual information analysis model to intelligently select the pertinent contextual information to provide via the halo contextual information shape and or beacon. For example, at any particular time the contextual user interface system 104 can identify multiple statuses and various contextual information items pertinent to a provider computing device. In one or more embodiments the contextual user interface system 104 utilizes a rank order of contextual information items to decide what to surface to user interfaces of provider computing devices.

The contextual user interface system 104 can utilize a contextual information analysis model. As used herein, a contextual information analysis model refers to a computer-implemented model for analyzing or selecting contextual information/contextual information items. In particular, a contextual information analysis model includes a computer-implemented model for generating a rank order of contextual information items. The contextual user interface system 104 can utilize a variety of computer-implemented models. To illustrate, in some implementations the contextual user interface system 104 utilizes a heuristic model to select contextual information to surface via a user interface. For example, the contextual user interface system 104 can prioritize a first status relative to a second status or a first contextual information item relative to a second contextual information item. In some embodiments, the contextual user interface system 104 prioritizes changes in transportation features corresponding to a location of a provider device relative to a change in transportation right status or an external signal status change.

In some implementations, the contextual user interface system 104 utilizes heuristics based on a variety of features or factors. For instance, the contextual user interface system 104 can prioritize contextual information items corresponding to safety, environmental factors, lane-level guidance, and rideshare states (e.g., in that hierarchical order or a revised hierarchical order). Similarly, the contextual user interface system 104 can prioritize based on relevancy, such as based on location or proximity. To illustrate, in some embodiments, contextual user interface system 104 utilizes a hierarchy based on categories of contextual information items, such as safety, information impairment (i.e., negative statuses such as an impairment to a mobile device indicating low connectivity), guidance (e.g., contextual information related to navigation), and then rideshare status. In some implementations, the contextual user interface system 104 further ranks contextual information items within each class or category (i.e., within sub-hierarchies).

In some embodiments the contextual user interface system 104 determines weights or scores corresponding to different contextual information items to determine a rank order. For example, the contextual user interface system 104 can determine a weight or score based on a distance or time corresponding to a particular contextual information item. To illustrate, the contextual user interface system 104 can assign a higher score or weight for a contextual information item that is closer in time or space. The contextual user interface system 104 can also assign a higher weight or score based on a measure of risk corresponding to a contextual information item. Thus, contextual information items such as traffic accidents or lean changes can have a higher weight or score relative to lower risk contextual information such as low GPS signal.

In one more implementations, that contextual user interface system 104 utilizes a machine learning model to select the contextual information item to surface. As used herein, the term “machine learning model” refers to a computer algorithm or a collection of computer algorithms that automatically improve for a particular task through experience based on use of data. For example, a machine learning model can be tuned or trained based on historical information to learn to approximate unknown functions. Example machine learning models include various types of decision trees, support vector machines, Bayesian networks, linear regressions, logistic regressions, random forest models, or neural networks.

For example, the contextual user interface system 104 can train a machine learning model based on historical information comprising historical statuses and historical contextual information items. The contextual user interface system 104 can utilize crowdsourcing or another technique to determine ground truth information indicating the particular statuses or contextual information items preferred by provider competing devices. The contextual user interface system 104 can generate a predicted contextual information item to provide (e.g., a score or rank) and compare the predicted contextual information item to the ground truth. For instance, in some implementations the contextual user interface system 104 utilizes a loss function to generate a measure of loss. The contextual user interface system 104 can utilize the measure of loss to update parameters of the machine learning model (e.g., via backpropagation and/or gradient descent).

At inference time, the contextual user interface system 104 can utilize the trained machine learning model to select a contextual information item to provide to a client device. Specifically, the contextual user interface system 104 can provide the available contextual information item and or statuses corresponding to a provider computing device to the machine learning model and utilize the machine learning model to generate predicted contextual information scores for the statuses/contextual information items. The contextual user interface system 104 can generate a rank order of contextual information items based on these scores and select the contextual information item to provide to the provider computing device based on the rank order. For example, in one or more embodiments the contextual user interface system 104 selects the contextual information item with the highest rank order.

The contextual user interface system 104 can iteratively utilize a computer implemented model to select the most appropriate contextual information item to provide to a provider computing device. In particular, the contextual user interface system 104 can actively monitor signals from the provider computing device, determine current contextual information items corresponding to the provider computing device, generate scores for the contextual information items, determine a rank order of the contextual information items, and select a particular contextual information item to surface to the provider computing device based on the rank order.

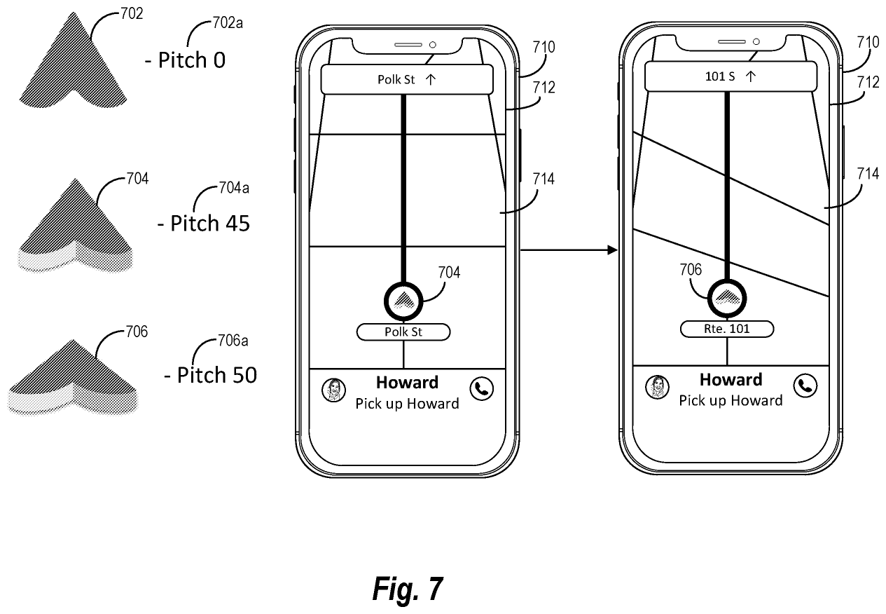

As mentioned above, in some implementations the contextual user interface system 104 can also modify the compass. For example, in some embodiments the contextual user interface system 104 generates different two-dimensional or three-dimensional compass representations based on a pitch level corresponding to a camera view for displaying a digital map. For instance, FIG. 7 illustrates generating a plurality of three-dimensional compass representations based on a camera view for displaying a digital map in accordance with one or more embodiments.

Specifically, FIG. 7 illustrates a plurality of pitch levels 702a-706a. As shown, the contextual user interface system 104 generates a plurality of three-dimensional compass representations 702-706 corresponding to the plurality of pitch at levels 702a-706a. To illustrate, for a pitch level of 0 degrees (e.g., an overhead view), the contextual user interface system 104 generates a first three dimensional compass representation 702 where the sides of the three-dimensional compass representation are not visible. For a pitch level of 45 degrees, the contextual user interface system 104 generates a second three dimensional compass representation where the sides of the compass are more visible and the compass shape is flattened according to the camera angle of the pitch level. Similarly, for a pitch level of 50 degrees the contextual user interface system 104 generates a three dimensional compass representation 706 where the sides of the compass are even more visible and the compass shape is flattened according to the modified camera angle of the pitch level.

The contextual user interface system 104 can determine the pitch level according to a variety of factors. For example, in some implementations the contextual user interface system 104 determines the pitch level based on a user interaction adjusting a camera angle. In some implementations, the contextual user interface system 104 determines the pitch level based on a speed of travel of the provider computing device (e.g., higher pitch level for higher speed). In some embodiments, the contextual user interface system 104 selects the pitch level based on characteristics of the digital map (e.g., higher concentrations of roads or buildings results in a higher pitch level). In one more implementations, the contextual user interface system 104 chooses the pitch level based on a route (e.g., a straight route in one direction will have a higher pitch angle, but a route that changes direction will have a smaller pitch angle).

As shown in FIG. 7, the contextual user interface system 104 can dynamically modify the pitch angle and the three-dimensional compass representation within a digital map. Specifically, FIG. 7 illustrates a provider computing device 710 having a user interface 712 displaying a digital map 714. The contextual user interface system 104 renders the digital map 714 from the perspective of a camera having a camera angle set according to a determined pitched level of 45 degrees. In response, the contextual user interface system 104 utilizes the three-dimensional compass representation 704 that aligns with the pitch level and camera angle. In addition, FIG. 7 illustrates changing the camera angle based on a different pitch level. Specifically, the contextual user interface system 104 utilizes a pitch angle of 50 degrees. Upon detecting the different camera angle the contextual user interface system 104 utilizes the three-dimensional compass representation 706 within the digital map 714 of the user interface 712.

Although FIG. 7 illustrates different three-dimensional compass representations, the contextual user interface system 104 can also generate different two-dimensional compass representations based on changing pitch level. For example, the contextual user interface system 104 can widen and shorten a two-dimensional compass representation based on a particular pitch level (without necessarily including a visual depiction of a side dimension of the compass).

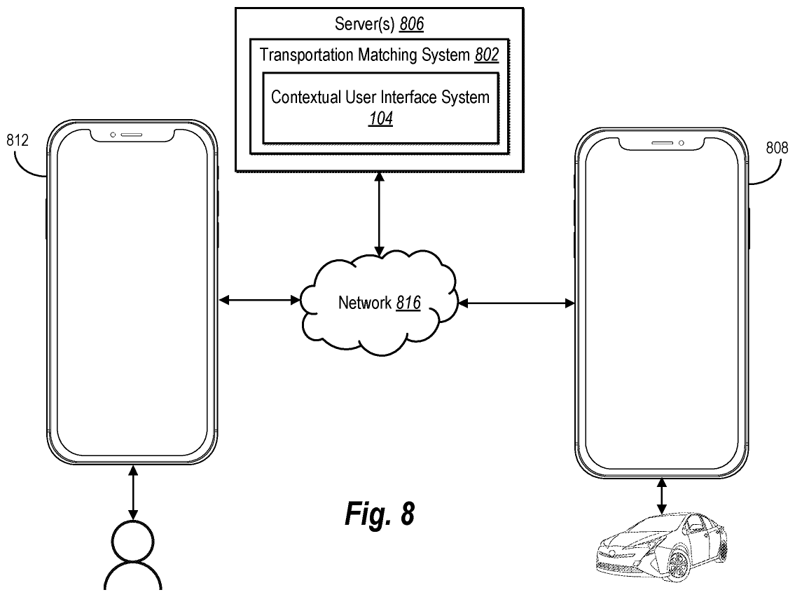

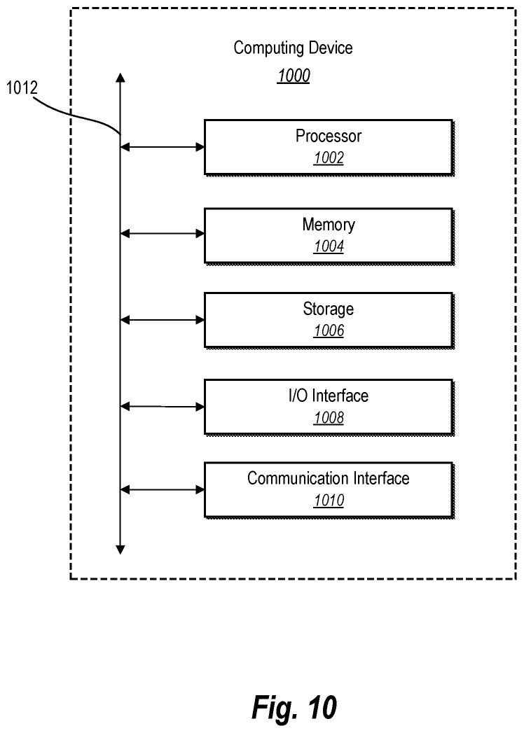

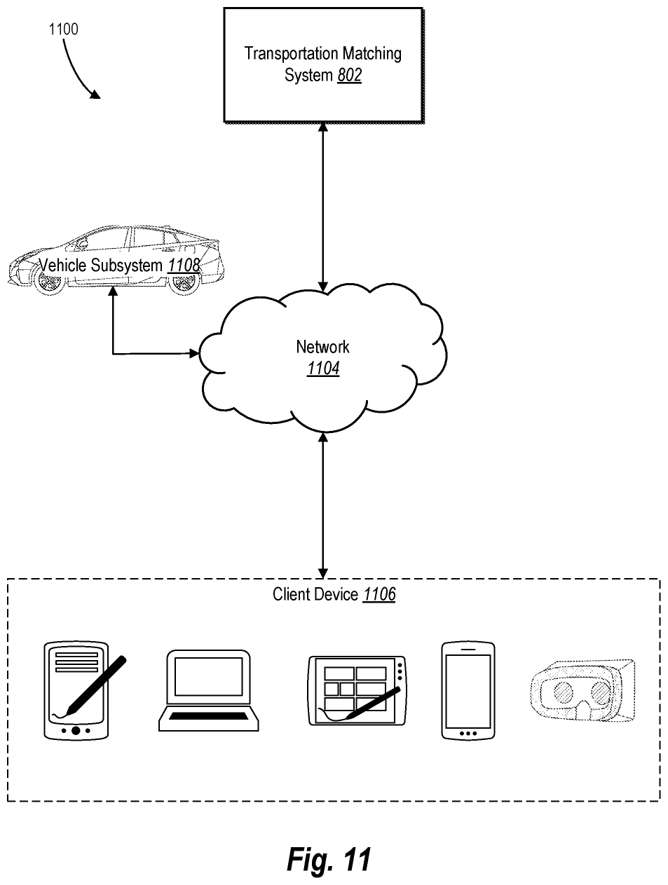

FIG. 8 illustrates a block diagram of a system environment for implementing the contextual user interface system 104 in accordance with one or more embodiments. As shown in FIG. 8, the environment includes server(s) 806 housing the contextual user interface system 104 as part of a transportation matching system 802. The environment of FIG. 8 further includes a provider device 808 (including a provider application) and a requester device 812 (including a requester application), as well as a network 816. The server(s) 806 can include one or more computing devices to implement the contextual user interface system 104. Additional detail regarding the illustrated computing devices (e.g., the server(s) 806, the provider devices 808, and/or the requester device 812) is provided with respect to FIGS. 10-11 below.

As shown, the contextual user interface system 104 utilizes the network 816 to communicate with the provider device 808 (and other provider devices) and the requester device 812 (and other requester devices). The network 816 may comprise any network described in relation to FIGS. 10-11. For example, the contextual user interface system 104 communicates with the provider device 808 (and other provider devices) and the requester device 812 to match transportation requests received from the requester device 812 with the provider device 808 (or another provider device). Indeed, the transportation matching system 802 or the contextual user interface system 104 can receive a transportation request from the requester device 812 and can provide request information to various provider device, such as a requested location (e.g., a requested pickup location and/or a requested drop-off location), a requester identification (for a requester corresponding to the requester device 812), and a requested pickup time. In some embodiments, per device settings, the transportation matching system 802 or the contextual user interface system 104 receives device information from various provider devices and the requester device 812, such as location coordinates (e.g., latitude, longitude, and/or elevation), orientations or directions, motion information, and indications of user interactions with various interface elements.

To facilitate connecting requests with transportation vehicles, in some embodiments, the transportation matching system 802 or the contextual user interface system 104 communicates with the provider device 808 and other provider devices (e.g., through a provider application). The provider device 808 further includes the provider application. In many embodiments, the transportation matching system 802 or the contextual user interface system 104 communicates with the provider device 808 through the provider application to, for example, receive and provide information including location data, motion data, transportation request information (e.g., pickup locations and/or drop-off locations), and transportation route information for navigating to one or more designated locations.

Similarly, the transportation matching system 802 or the contextual user interface system 104 communicates with the requester device 812 (e.g., through the requester application) to facilitate connecting requests with transportation vehicles. In many embodiments, the contextual user interface system 104 communicates with the requester device 812 through the requester application to, for example, receive and provide information including location data, motion data, transportation request information (e.g., requested locations), and navigation information to guide a requester to a designated location.

As indicated above, the transportation matching system 802 or the contextual user interface system 104 can provide (and/or cause the provider device 808 to display or render) visual elements within a graphical user interface associated with the provider application and the requester application. For example, the transportation matching system 802 or the contextual user interface system 104 can provide a digital map for display on the provider device 808 that illustrates a transportation route to navigate to a designated location. The contextual user interface system 104 can also provide transportation request notification for display on the provider device 808 indicating a transportation request. As outlined above, the contextual user interface system 104 can also provide for display a compass, dynamic halo, contextual information shape, and/or beacon.

Moreover, as illustrated the contextual user interface system 104 provides a user interface via the requester device 812 that includes selectable options for various types of transportation requests (e.g., a standard transportation request type, a time priority airport transportation request type, and/or a flexible time delay airport transportation request type). In response to selection of an option, the contextual user interface system 104 identifies a provider device to match to the requester device 812. In addition, the contextual user interface system 104 can provide a digital map for display on the requester device 812, where the digital map illustrates transportation routes.

The contextual user interface system 104 selects one or more provider devices as a recipient for a transportation request received from the requester device 812 based on various factors. Such factors may include a provider device status, time metrics, ranking orders, provider incentives, requester incentives, a time of day, traffic information, and/or other transportation matching considerations.

Although FIG. 8 illustrates the environment having a particular number and arrangement of components associated with the contextual user interface system 104, in some embodiments, the environment may include more or fewer components with varying configurations. For example, in some embodiments, the transportation matching system 802 or the contextual user interface system 104 can communicate directly with the provider device 808 and/or the requester device 812, bypassing the network 816. In these or other embodiments, the transportation matching system 802 or the contextual user interface system 104 can be housed (entirely on in part) on the provider device 808 and/or the requester device 812. Additionally, the transportation matching system 802 or the contextual user interface system 104 can include or communicate with a database for storing information, such as various machine learning models, historical data (e.g., historical provider device and/or requester device patterns), transportation requests, and/or other information described herein.

In one or more embodiments, each of the components of the contextual user interface system 104 are in communication with one another using any suitable communication technologies. Additionally, the components of the contextual user interface system 104 can be in communication with one or more other devices including one or more client devices described above. Furthermore, although the components of FIG. 8 are described in connection with the contextual user interface system 104, at least some of the components for performing operations in conjunction with the contextual user interface system 104 described herein may be implemented on other devices within the environment.

The components of the contextual user interface system 104 can include software, hardware, or both. For example, the components of the contextual user interface system 104 can include one or more instructions stored on a computer-readable storage medium and executable by processors of one or more computing devices. When executed by the one or more processors, the computer-executable instructions of the contextual user interface system 104 can cause the computing device to perform the methods described herein. Alternatively, the components of the contextual user interface system 104 can comprise hardware, such as a special purpose processing device to perform a certain function or group of functions. Additionally or alternatively, the components of the contextual user interface system 104 can include a combination of computer-executable instructions and hardware.

Furthermore, the components of the contextual user interface system 104 performing the functions described herein may, for example, be implemented as part of a stand-alone application, as a module of an application, as a plug-in for applications including content management applications, as a library function or functions that may be called by other applications, and/or as a cloud-computing model. Thus, the components of the contextual user interface system 104 may be implemented as part of a stand-alone application on a personal computing device or a mobile device. Alternatively or additionally, the components of the contextual user interface system 104 may be implemented in any application that allows creation and delivery of marketing content to users, including, but not limited to, various applications.

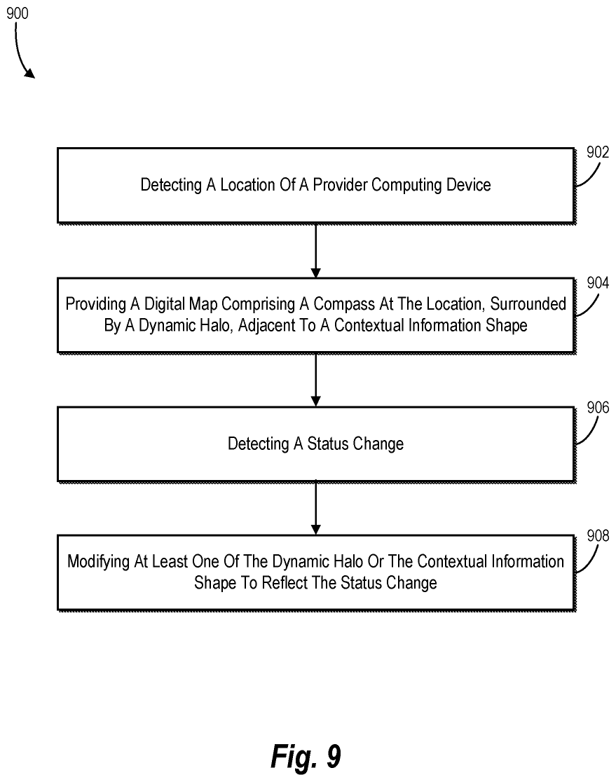

FIGS. 1-8, the corresponding text, and the examples provide a number of different systems, methods (computer-implemented methods), and non-transitory computer readable media for selecting and providing a transportation request to a limited-eligibility provider device. In addition to the foregoing, embodiments can also be described in terms of flowcharts comprising acts for accomplishing a particular result. For example, FIG. 9 illustrates a flowchart of an example sequence of acts in accordance with one or more embodiments.

While FIG. 9 illustrates acts according to some embodiments, alternative embodiments may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further embodiments, a system can perform the acts of FIG. 9. Additionally, the acts described herein may be repeated or performed in parallel with one another or in parallel with different instances of the same or other similar acts.

FIG. 9 illustrates an example series of acts 900 for matching provider devices to time priority airport transportation requests in accordance with one or more embodiments. As shown, the series of acts 900 includes acts 902-908 of detecting a location of a provider computing device; providing a digital map comprising a compass at the location, surrounded by a dynamic halo, adjacent to a contextual information shape; detecting a status change; and modifying at least one of the dynamic halo or the contextual information shape to reflect the status change.

To illustrate, in one or more implementations the acts 902-908 include: detecting, utilizing global positioning data, a location of a provider computing device; providing, for display via a user interface of the provider computing device, a digital map comprising a compass at the location, surrounded by a dynamic halo, adjacent to a contextual information shape; detecting a status change corresponding to the provider computing device; in response to detecting the status change, selecting, utilizing a contextual information analysis model, a contextual information item from a plurality of contextual information items corresponding to the provider computing device; and modifying the dynamic halo and the contextual information shape within the user interface of the provider computing device to reflect the contextual information item.

For example, in one or more implementations the acts 902-908 include: detecting, utilizing global positioning data, a location of a provider computing device; providing, for display via a user interface of the provider computing device, a digital map comprising a compass at the location, surrounded by a dynamic halo, adjacent to a contextual information shape; detecting a status change corresponding to the provider computing device; and modifying the dynamic halo and the contextual information shape within the user interface of the provider computing device to reflect the status change.

In one or more implementations, modifying the dynamic halo comprises changing the dynamic halo from a first color corresponding to a first status to a second color corresponding to a second status based on the status change. Furthermore, in some implementations, modifying the contextual information shape comprises changing the contextual information shape from a first set of textual information corresponding to the first status to a second set of textual information corresponding to the second status based on the status change.

In addition, in one or more implementations, detecting the status change corresponding to the provider computing device comprises detecting at least one of: a change in external signals available to the provider computing device; a change in transportation ride state corresponding to a transportation matching system; or a change in transportation features corresponding to the location of the provider computing device. Moreover, in some implementations, detecting the status change comprises detecting a first direction corresponding to the status change and further comprising providing, for display, a beacon on a first side of the compass corresponding to the first direction.

In some implementations, detecting the status change comprises detecting a side of a street corresponding to at least one of a requestor computing device matched to the provider computing device, a curb restriction corresponding to the side of the street, or navigational instructions corresponding to the side of the street; and the series of acts 900 includes providing, for display, the beacon on the first side of the compass corresponding to the side of the street. Further, in one or more implementations, providing the compass for display via the user interface comprises: detecting a pitch level corresponding to a camera view for displaying the digital map; and providing a three-dimensional compass representation based on the pitch level.

In addition, in some implementations, the series of acts 900 includes detecting a modified pitch level corresponding to the camera view for displaying the digital map; and providing a modified three-dimensional compass representation based on the modified pitch level. In one or more implementations, the series of acts 900 includes determining a rank order of contextual information; and modifying the dynamic halo and the contextual information shape within the user interface of the provider computing device to reflect the status change based on the rank order of contextual information.

Moreover, in some implementations, providing the compass for display via the user interface comprises: detecting a pitch level corresponding to a camera view for displaying the digital map; and providing a compass representation based on the pitch level. In addition, in some implementations, the series of acts 900 includes detecting a modified pitch level corresponding to the camera view for displaying the digital map; and providing a modified compass representation based on the modified pitch level. Further, in some embodiments, the series of acts 900 includes determining a rank order of contextual information items utilizing the contextual information analysis model; and selecting the contextual information item from the rank order of contextual information items.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAS, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 (e.g., the provider device 808, the requester device 812, or the server(s) 806) that may be configured to perform one or more of the processes described above. One will appreciate that the contextual user interface system 104 can comprise implementations of the computing device 1000, including, but not limited to, the provider device 808 and/or the server(s) 806. As shown by FIG. 10, the computing device can comprise a processor 1002, memory 1004, a storage device 1006, an I/O interface 1008, and a communication interface 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, storage device 1006 can comprise a non-transitory storage medium described above. The storage device 1006 may include a hard disk drive (“HDD”), flash memory, a Universal Serial Bus (“USB”) drive or a combination of these or other storage devices.

The computing device 1000 also includes one or more input or output interface 1008 (or “I/O interface 1008”), which are provided to allow a user (e.g., requester or provider) to provide input to (such as user strokes), receive output from, and otherwise transfer data to and from the computing device 1000. These I/O interface 1008 may include a mouse, keypad or a keyboard, a touch screen, camera, optical scanner, network interface, modem, other known I/O devices or a combination of such I/O interface 1008. The touch screen may be activated with a stylus or a finger.

The I/O interface 1008 may include one or more devices for presenting output to a user, including, but not limited to, a graphics engine, a display (e.g., a display screen), one or more output providers (e.g., display providers), one or more audio speakers, and one or more audio providers. In certain embodiments, interface 1008 is configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices 1000 or one or more networks. As an example, and not by way of limitation, communication interface 1010 may include a network interface controller (“NIC”) or network adapter for communicating with an Ethernet or other wire-based network or a wireless NIC (“WNIC”) or wireless adapter for communicating with a wireless network, such as a WI-FI. The computing device 1000 can further include a bus 1012. The bus 1012 can comprise hardware, software, or both that connects components of computing device 1000 to each other.

FIG. 11 illustrates an example network environment 1100 of the transportation matching system 802. The network environment 1100 includes a client device 1106 (e.g., the provider devices 808 or the requester device 812), a transportation matching system 802, and a vehicle subsystem 1108 connected to each other by a network 1104. Although FIG. 11 illustrates a particular arrangement of the client device 1106, the transportation matching system 802, the vehicle subsystem 1108, and the network 1104, this disclosure contemplates any suitable arrangement of client device 1106, the transportation matching system 802, the vehicle subsystem 1108, and the network 1104. As an example, and not by way of limitation, two or more of client device 1106, the transportation matching system 802, and the vehicle subsystem 1108 communicate directly, bypassing network 1104. As another example, two or more of client device 1106, the transportation matching system 802, and the vehicle subsystem 1108 may be physically or logically co-located with each other in whole or in part.

Moreover, although FIG. 11 illustrates a particular number of client devices 1106, transportation matching systems 802, vehicle subsystems 1108, and networks 1104, this disclosure contemplates any suitable number of client devices 1106, transportation matching system 802, vehicle subsystems 1108, and networks 1104. As an example, and not by way of limitation, network environment 1100 may include multiple client device 1106, transportation matching system 802, vehicle subsystems 1108, and/or networks 1104.

This disclosure contemplates any suitable network 1104. As an example, and not by way of limitation, one or more portions of network 1104 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1104 may include one or more networks 1104.

Links may connect client device 1106, contextual user interface system 104, and vehicle subsystem 1108 to network 1104 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1100. One or more first links may differ in one or more respects from one or more second links.

In particular embodiments, the client device 1106 may be an electronic device including hardware, software, or embedded logic components or a combination of two or more such components and capable of carrying out the appropriate functionalities implemented or supported by client device 1106. As an example, and not by way of limitation, a client device 1106 may include any of the computing devices discussed above in relation to FIG. 11. A client device 1106 may enable a network user at the client device 1106 to access network 1104. A client device 1106 may enable its user to communicate with other users at other client devices 1106.

In particular embodiments, the client device 1106 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1106 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1106 one or more Hyper Text Markup Language (“HTML”) files responsive to the HTTP request. The client device 1106 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 802 may be a network-addressable computing system that can host a transportation matching network. The transportation matching system 802 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 802. In addition, the transportation matching system 802 may manage identities of service requesters such as users/requesters. In particular, the transportation matching system 802 may maintain requester data such as driving/riding histories, personal data, or other user data in addition to navigation and/or traffic management services or other location services (e.g., GPS services).

In particular embodiments, the transportation matching system 802 may manage transportation matching services to connect a user/requester with a vehicle and/or provider. By managing the transportation matching services, the transportation matching system 802 can manage the distribution and allocation of resources from vehicle systems and user resources such as GPS location and availability indicators, as described herein.

The transportation matching system 802 may be accessed by the other components of network environment 1100 either directly or via network 1104. In particular embodiments, the transportation matching system 802 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 802 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1106, or a transportation matching system 802 to manage, retrieve, modify, add, or delete, the information stored in data store.

In particular embodiments, the transportation matching system 802 may provide users with the ability to take actions on various types of items or objects, supported by the transportation matching system 802. As an example, and not by way of limitation, the items and objects may include transportation matching networks to which users of the transportation matching system 802 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 802 or by an external system of a third-party system, which is separate from transportation matching system 802 and coupled to the transportation matching system 802 via a network 1104.

In particular embodiments, the transportation matching system 802 may be capable of linking a variety of entities. As an example, and not by way of limitation, the transportation matching system 802 may enable users to interact with each other or other entities, or to allow users to interact with these entities through an application programming interfaces (“API”) or other communication channels.

In particular embodiments, the transportation matching system 802 may include a variety of servers, sub-systems, programs, modules, logs, and data stores. In particular embodiments, the transportation matching system 802 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. The transportation matching system 802 may also include suitable components such as network interfaces, security mechanisms, load balancers, failover servers, management-and-network-operations consoles, other suitable components, or any suitable combination thereof. In particular embodiments, the transportation matching system 802 may include one or more user-profile stores for storing user profiles for transportation providers and/or transportation requesters. A user profile may include, for example, biographic information, demographic information, behavioral information, social information, or other types of descriptive information, such as interests, affinities, or location.

The web server may include a mail server or other messaging functionality for receiving and routing messages between the transportation matching system 802 and one or more client devices 1106. An action logger may be used to receive communications from a web server about a user's actions on or off the transportation matching system 802. In conjunction with the action log, a third-party-content-object log may be maintained of user exposures to third-party-content objects. A notification controller may provide information regarding content objects to a client device 1106. Information may be pushed to a client device 1106 as notifications, or information may be pulled from client device 1106 responsive to a request received from client device 1106. Authorization servers may be used to enforce one or more privacy settings of the users of the transportation matching system 802. A privacy setting of a user determines how particular information associated with a user can be shared. The authorization server may allow users to opt in to or opt out of having their actions logged by the transportation matching system 802 or shared with other systems, such as, for example, by setting appropriate privacy settings. Third-party-content-object stores may be used to store content objects received from third parties. Location stores may be used for storing location information received from client devices 1106 associated with users.

In addition, the vehicle subsystem 1108 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1108 can include an autonomous vehicle—e.g., a vehicle that does not require a human operator. In these embodiments, the vehicle subsystem 1108 can perform maneuvers, communicate, and otherwise function without the aid of a human provider, in accordance with available technology.

In particular embodiments, the vehicle subsystem 1108 may include one or more sensors incorporated therein or associated thereto. For example, sensor(s) can be mounted on the top of the vehicle subsystem 1108 or else can be located within the interior of the vehicle subsystem 1108. In certain embodiments, the sensor(s) can be located in multiple areas at once—e.g., split up throughout the vehicle subsystem 1108 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1108 may include a communication device capable of communicating with the client device 1106 and/or the contextual user interface system 104. For example, the vehicle subsystem 1108 can include an on-board computing device communicatively linked to the network 1104 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
detecting, utilizing global positioning data, a location of a provider computing device;
providing, for display via a user interface of the provider computing device, a digital map comprising a compass at the location, surrounded by a dynamic halo, adjacent to a contextual information shape;
detecting a status change corresponding to the provider computing device;
in response to detecting the status change, selecting, utilizing a contextual information analysis model, a contextual information item from a plurality of contextual information items corresponding to the provider computing device; and
modifying the dynamic halo and the contextual information shape within the user interface of the provider computing device to reflect the contextual information item.

2. The computer-implemented method of claim 1, wherein modifying the dynamic halo comprises changing the dynamic halo from a first color corresponding to a first status to a second color corresponding to a second status based on the status change.

3. The computer-implemented method of claim 2, wherein modifying the contextual information shape comprises changing the contextual information shape from a first set of textual information corresponding to the first status to a second set of textual information corresponding to the second status based on the status change.

4. The computer-implemented method of claim 1, wherein detecting the status change corresponding to the provider computing device comprises detecting at least one of: a change in external signals available to the provider computing device; a change in transportation ride state corresponding to a transportation matching system; or a change in transportation features corresponding to the location of the provider computing device.

5. The computer-implemented method of claim 1, wherein detecting the status change comprises detecting a first direction corresponding to the status change and further comprising providing, for display, a beacon on a first side of the compass corresponding to the first direction.

6. The computer-implemented method of claim 5,
wherein detecting the status change comprises detecting a side of a street corresponding to at least one of a requestor computing device matched to the provider computing device or a curb restriction corresponding to the side of the street; and
providing, for display, the beacon on the first side of the compass corresponding to the side of the street.

7. The computer-implemented method of claim 1, wherein providing the compass for display via the user interface comprises:
detecting a pitch level corresponding to a camera view for displaying the digital map; and
providing a compass representation based on the pitch level.

8. The computer-implemented method of claim 7, further comprising,
detecting a modified pitch level corresponding to the camera view for displaying the digital map; and
providing a modified compass representation based on the modified pitch level.

9. The computer-implemented method of claim 1, further comprising,
determining a rank order of contextual information items utilizing the contextual information analysis model; and
selecting the contextual information item from the rank order of contextual information items.

10. A system comprising:
at least one processor; and
a non-transitory computer readable storage medium comprising instructions that, when executed by the at least one processor, cause the system to:
detect, utilizing global positioning data, a location of a provider computing device;
provide, for display via a user interface of the provider computing device, a digital map comprising a compass at the location, surrounded by a dynamic halo, adjacent to a contextual information shape;
detect a status change corresponding to the provider computing device; and
in response to detecting the status change, selecting, utilizing a contextual information analysis model, a contextual information item from a plurality of contextual information items corresponding to the provider computing device;
modify the dynamic halo and the contextual information shape within the user interface of the provider computing device to reflect the contextual information item.

11. The system of claim 10, further comprising instructions that, when executed by the at least one processor, cause the system to modify the dynamic halo by changing the dynamic halo from a first color corresponding to a first status to a second color corresponding to a second status based on the status change.

12. The system of claim 11, further comprising instructions that, when executed by the at least one processor, cause the system to modify the contextual information shape by changing the contextual information shape from a first set of textual information corresponding to the first status to a second set of textual information corresponding to the second status based on the status change.

13. The system of claim 10, further comprising instructions that, when executed by the at least one processor, cause the system to detect the status change corresponding to the provider computing device by detecting at least one of: a change in external signals available to the provider computing device; a change in transportation ride state corresponding to a transportation matching system; or a change in transportation features corresponding to the location of the provider computing device.

14. The system of claim 10, further comprising instructions that, when executed by the at least one processor, cause the system to:
detect the status change by detecting a first direction corresponding to the status change; and
provide, for display, a beacon on a first side of the compass corresponding to the first direction.

15. The system of claim 10, further comprising instructions that, when executed by the at least one processor, cause the system to:
detect a pitch level corresponding to a camera view for displaying the digital map;
provide a compass representation based on the pitch level; and
in response to detecting a modified pitch level corresponding to the camera view for displaying the digital map, providing a modified compass representation based on the modified pitch level.

16. A non-transitory computer readable storage medium comprising instructions that, when executed by at least one processor, cause the at least one processor to:
detect, utilizing global positioning data, a location of a provider computing device;
provide, for display via a user interface of the provider computing device, a digital map comprising a compass at the location, surrounded by a dynamic halo, adjacent to a contextual information shape;
detect a status change corresponding to the provider computing device; and
modify the dynamic halo and the contextual information shape within the user interface of the provider computing device to reflect the status change.

17. The non-transitory computer readable storage medium of claim 16, further comprising instructions that, when executed by the at least one processor, cause the at least one processor to modify the dynamic halo by changing the dynamic halo from a first color corresponding to a first status to a second color corresponding to a second status based on the status change.

18. The non-transitory computer readable storage medium of claim 17, further comprising instructions that, when executed by the at least one processor, cause the at least one processor to modify the contextual information shape by changing the contextual information shape from a first set of textual information corresponding to the first status to a second set of textual information corresponding to the second status based on the status change.

19. The non-transitory computer readable storage medium of claim 16, further comprising instructions that, when executed by the at least one processor, cause the at least one processor to:
detect the status change by detecting a first direction corresponding to the status change; and
provide, for display, a beacon on a first side of the compass corresponding to the first direction.

20. The non-transitory computer readable storage medium of claim 16, further comprising instructions that, when executed by the at least one processor, cause the at least one processor to:
detect a pitch level corresponding to a camera view for displaying the digital map; and
providing a compass representation based on the pitch level.
